(19) United States
(12) Patent Application Publication
(10) Pub. No.: US 2023/0331014 A1
(43) Pub. Date: Oct. 19, 2023

(54) APPARATUS

(71) Applicant: SEIKO EPSON CORPORATION, Tokyo (JP)

(72) Inventors: Yutaro HARADA, SHIOJIRI-SHI (JP); Kazuyoshi OHASHI, MATSUMOTO-SHI (JP); Kohei UENO, MATSUMOTO-SHI (JP)

(21) Appl. No.: 18/301,114

(22) Filed: Apr. 14, 2023

(30) Foreign Application Priority Data
Apr. 18, 2022 (JP) 2022-068115

(51) Int. Cl. B41J 29/393

(52) U.S. Cl. CPC B41J 29/393

(57) ABSTRACT

An apparatus includes a component constituting an exterior of the apparatus itself and including an outer surface constituting the exterior, an information medium provided at an information medium surface of the component and configured to provide access to disassembly-related information related to disassembly of the apparatus itself, and a display portion provided covering the information medium and configured to display apparatus information different from the disassembly-related information.

The present application is based on, and claims priority from JP Application Serial Number 2022-068115, filed Apr. 18, 2022, the disclosure of which is hereby incorporated by reference herein in its entirety.

### BACKGROUND

### 1. Technical Field

The present disclosure relates to an apparatus.

### 2. Related Art

JP-A-2002-102836 discloses a facsimile apparatus as an example of an apparatus including a rear cover and a small cover fixed to the rear cover. Further, it is disclosed that a sheet on which information about a disassembling method of the facsimile apparatus itself is printed is attached to an outer surface of the small cover constituting a part of an exterior of the facsimile apparatus. The small cover is an example of a component constituting the exterior of the facsimile apparatus. Further, the sheet is an example of an information medium related to disassembly of the apparatus itself.

However, in the apparatus disclosed in JP-A-2002-102836, the information medium which is not necessary when a user uses the apparatus constitutes a part of the exterior of the apparatus, which may deteriorate the exterior of the apparatus.

### SUMMARY

An apparatus includes a component constituting an exterior of the apparatus itself and including an outer surface constituting the exterior, an information medium provided at the outer surface of the component and configured to provide access to disassembly-related information related to disassembly of the apparatus itself, and a display portion provided covering the information medium and configured to display apparatus information different from the disassembly-related information.

### BRIEF DESCRIPTION OF THE DRAWINGS

FIG. 1 is a perspective view illustrating an inner configuration of a recording apparatus as an embodiment of the present disclosure.

FIG. 2 is a right side view of the recording apparatus illustrated in FIG. 1.

FIG. 3 is a perspective view of the recording apparatus illustrated in FIG. 1.

FIG. 4 is a left side view of the recording apparatus illustrated in FIG. 1.

FIG. 5 is a perspective view of the recording apparatus illustrated in FIG. 1.

FIG. 6 is a front side view of the recording apparatus illustrated in FIG. 1.

FIG. 7 is a perspective view of a detection target portion.

FIG. 8 is a perspective view of a detection target portion.

FIG. 9 is a cross-sectional view illustrating a S9 to S9 cross section illustrated in FIG. 6.

FIG. 10 is a view of an operation button provided on a front wall when seen from the back side of a housing.

FIG. 11 is a right side view of the operation button.

FIG. 12 is a cross-sectional view illustrating a S12 to S12 cross section illustrated in FIG. 4.

FIG. 13 is a cross-sectional view illustrating a S13 to S13 cross section illustrated in FIG. 4.

FIG. 14 is a partially enlarged view of a vicinity of a mounting surface of a display portion.

FIG. 15 is a cross-sectional view illustrating a S15 to S15 cross section illustrated in FIG. 4.

FIG. 16 is a partial enlarged view of the vicinity of the mounting surface of the display portion.

FIG. 17 is a partial enlarged view of the vicinity of the mounting surface of the display portion.

FIG. 18 is a cross-sectional view illustrating a S17 to S17 cross section illustrated in FIG. 7.

### DESCRIPTION OF EXEMPLARY EMBODIMENTS

Hereinafter, the present disclosure will be described based on embodiments. In the drawings, the same members are designated by the same reference numerals, and overlapping descriptions will be omitted. In the present specification, “the same”, “identical”, and “simultaneously” refer to being exactly the same, and also include a case of being the same in consideration of measurement errors, a case of being the same in consideration of manufacturing variations of members, and a case of being the same within a range that does not impair functions. Thus, for example, “both dimensions are the same” means that a dimensional difference between the two dimensions is within ±10%, may be within ±5%, and may be within ±3% of one dimension in consideration of measurement errors and manufacturing variations of members.

In addition, X, Y, and Z in each of the drawings represent three spatial axes orthogonal to each other. In the specification, directions along the axes are referred to as an X-axis direction, a Y-axis direction, and a Z-axis direction. When the direction is identified, a positive direction is defined as “+”, a negative direction is defined as “-”, both positive and negative signs are used for direction notation, and a direction in which an arrow in each of the drawings is described as a +direction, and a direction opposite to the arrow is described as a -direction.

Additionally, the Z-axis direction indicates a direction of gravity, the +Z direction indicates a vertical downward direction, and the -Z direction indicates a vertical upward direction. A plane including the X axis and the Y axis is described as an X-Y plane, a plane including the X axis and the Z axis is described as an X-Z plane, and a plane including the Y axis and the Z axis is described as a Y-Z plane. Also, the X-Y plane is a horizontal plane. Furthermore, the three spatial axes of X, Y, and Z that are not limited to positive and negative directions will be described as the X axis, Y axis, and Z axis.

In addition, in each of the drawings, an X-axis direction is a width direction of a housing 17 which will be described below, and is also a direction intersecting a transport direction in which a medium M is transported, that is, a width direction of the medium M. In the embodiment, among side surfaces constituting the periphery of the housing 17, a side surface on which the operation button 32 is provided is a front surface of the housing 17. In the X-axis direction, the -X direction is a left direction when seen from the user when the front surface of the housing 17 faces the user, and the +X direction is a right direction when seen from the user.

The Y direction is an inward direction. In the Y-axis direction, the -Y direction is a direction from the front surface of the housing 17 toward a rear surface of the housing 17. Also, in the Y-axis direction, the +Y direction is a direction from the rear surface of the housing 17 toward the front surface of the housing 17.

### 1. Embodiment 1

A recording apparatus 11 according to Embodiment 1 is, for example, an inkjet printer that performs recording by ejecting ink that is an example of a liquid onto a medium M such as paper.

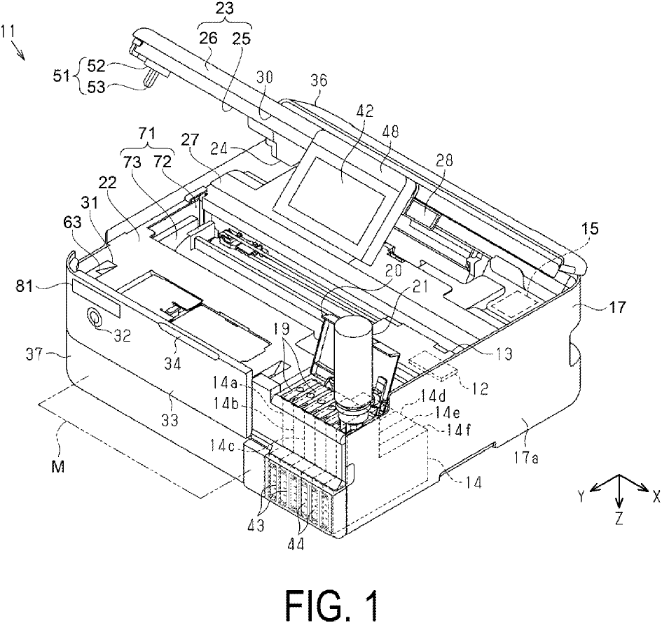

As illustrated in FIG. 1, the recording apparatus 11 includes a housing 17, a liquid ejection head 12, a carriage 13, a storage portion 14, and a control portion 15. The recording apparatus 11 is an example of an apparatus. The housing 17 accommodates the liquid ejection head 12, the carriage 13, the storage portion 14, and a transport portion (not illustrated). The housing 17 of the embodiment is formed of a resin material, for example, a polystyrene (PS) resin. The housing 17 is an example of a component EP constituting an exterior of the recording apparatus 11 itself and including an outer surface constituting the exterior of the recording apparatus 11 itself.

The liquid ejection head 12 ejects a liquid. The carriage 13 movably holds the liquid ejection head 12. The storage portion 14 stores the liquid. The recording apparatus 11 includes a plurality of storage portions 14. The liquid ejection head 12 performs recording on the medium M by ejecting a plurality of types of liquid stored in the plurality of storage portions 14. The liquid ejection head 12 ejects liquid while moving in the width direction of the medium M together with the carriage 13, and performs recording on the medium M transported by the transport portion.

A front cover 22 and a rear cover 27 that cover the -Z direction side of the medium M transported by the transport portion are provided in the housing 17. The front cover 22 is provided on the +Y direction side of a region in which the carriage 13 moves. The rear cover 27 is provided on the -Y direction side of the region in which the carriage 13 moves. A detection hole 31 into which a protrusion 53 of a detection target portion 51 described below can enter is provided in the front cover 22.

The housing 17 accommodates the plurality of storage portions 14. Each of the storage portions 14 may be fixed to the housing 17, or may be removably mounted in the housing 17. Each of the storage portions 14 of the embodiment is a tank including an injection port (not illustrated) through which liquid can be injected, and is fixed to the housing 17.

The recording apparatus 11 of the embodiment includes six storage portions 14. The six storage portions 14 have the same configuration although they contain different types of accommodated liquid. In the embodiment, the storage portions 14 are referred to as storage portions 14 when they are not distinguished from each other, and are referred to as storage portions 14a, 14b, 14c, 14d, 14e, and 14f when they are distinguished from each other. The housing 17 of the embodiment accommodates the storage portions 14a, 14b, 14c, 14d, 14e, and 14f.

The storage portions 14a, 14b, 14c, 14d, 14e, and 14f store first to sixth liquids, respectively. The liquid ejection head 12 of the embodiment ejects the first to sixth liquids. The type of liquid ejected by the liquid ejection head 12 varies according to the number of the storage portions 14. For example, when the housing 17 accommodates the storage portion 14a and the storage portion 14b, the liquid ejection head 12 ejects a first liquid stored in the storage portion 14a and a second liquid stored in the storage portion 14b.

The first to sixth liquids are inks having different colors, for example. The first liquid to the sixth liquid may include a liquid used for maintenance of the recording apparatus 11 such as a moisturizing liquid in addition to the ink. The color of the ink may be arbitrarily selected from cyan, magenta, yellow, black, photo black, matte black, light cyan, light magenta, vivid magenta, vivid light magenta, grey, light grey, dark grey, orange, green, red, violet, deep blue, metallic silver, white, and the like.

The recording apparatus 11 includes a plurality of plugs 19 that respectively close the plurality of storage portions 14, and a supply cover 20 that covers the plurality of plugs 19. The plurality of plugs 19 respectively close the injection ports (not illustrated) of the plurality of storage portions 14. When the liquid is supplied to the storage portion 14, a user positions the supply cover 20 and the plug 19 at open positions and couples a supply container 21 accommodating the liquid for supply to the storage portion 14.

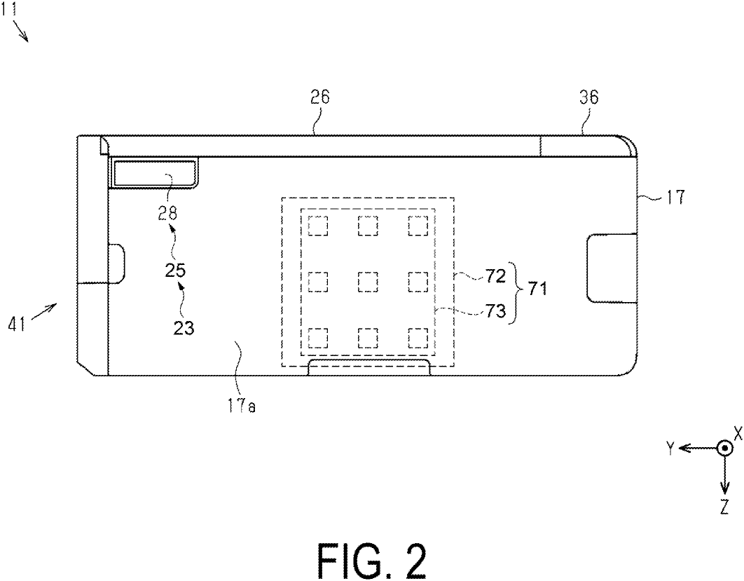

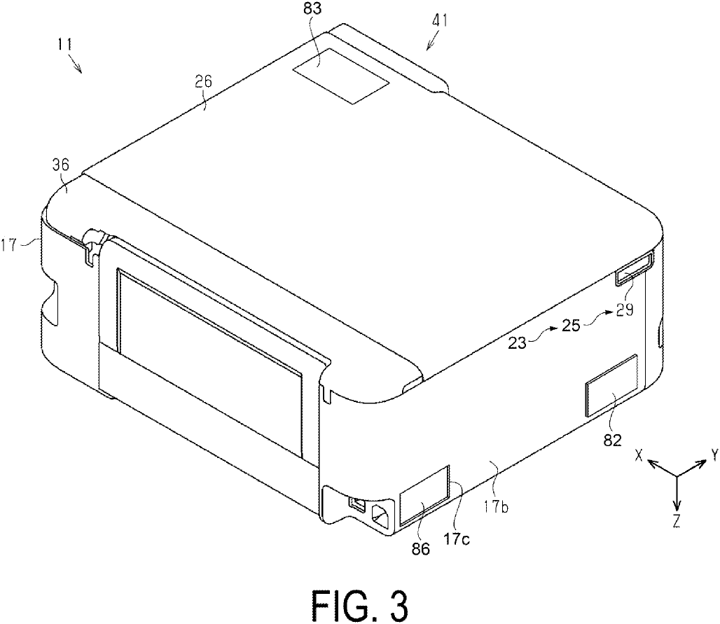

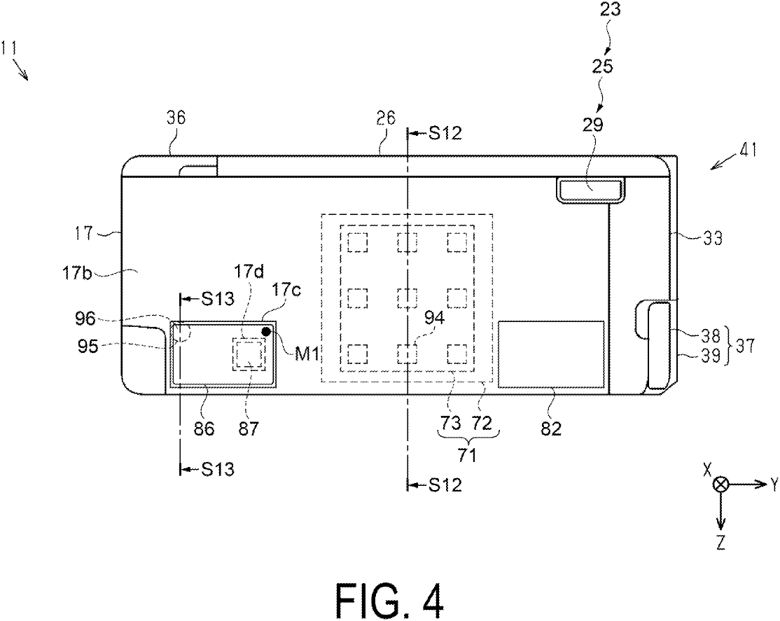

The recording apparatus 11 includes a reading mechanism 23 that reads an image printed on a document, and a swing mechanism 24 including a hinge. The reading mechanism 23 includes a reading portion 25 and an upper lid 26. The swing mechanism 24 supports a rear end of the reading mechanism 23 which is an end on the -Y direction side. The reading mechanism 23 swings about the swing mechanism 24. As illustrated in FIGS. 1 and 2, the reading portion 25 includes a first handle portion 28 provided on the right side wall 17a side of the housing 17. As illustrated in FIGS. 3 and 4, the reading portion 25 includes a second handle portion 29 provided on the left side wall 17b side of the housing 17.

The reading mechanism 23 located at a closed position illustrated in FIGS. 2 to 6 is moved to an open position illustrated in FIG. 1 by being lifted upward by the user who holds the first handle portion 28 and the second handle portion 29. When the reading mechanism 23 is located at the open position, the supply cover 20 can be opened and closed. The reading mechanism 23 located at the open position moves to the closed position illustrated in FIGS. 2 to 6 by being pushed down by the user.

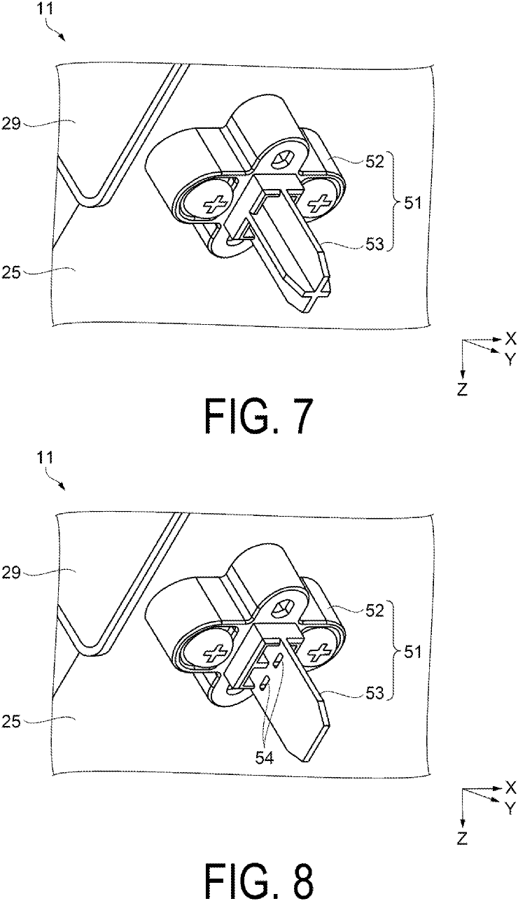

As illustrated in FIGS. 1 and 7, a detection target portion 51 is provided in the reading portion 25. The detection target portion 51 includes a fixing portion 52 and a protrusion 53. The protrusion 53 of the embodiment is formed of, for example, stainless steel or a plated iron material. The protrusion 53 of the embodiment has a cross shape when seen in a direction along a direction in which the protrusion 53 protrudes from the fixing portion 52. The detection target portion 51 is mounted in the reading portion 25 by the fixing portion 52 being fixed to the reading portion 25. The detection target portion 51 moves along with movement of the reading portion 25 between the closed position and the open position.

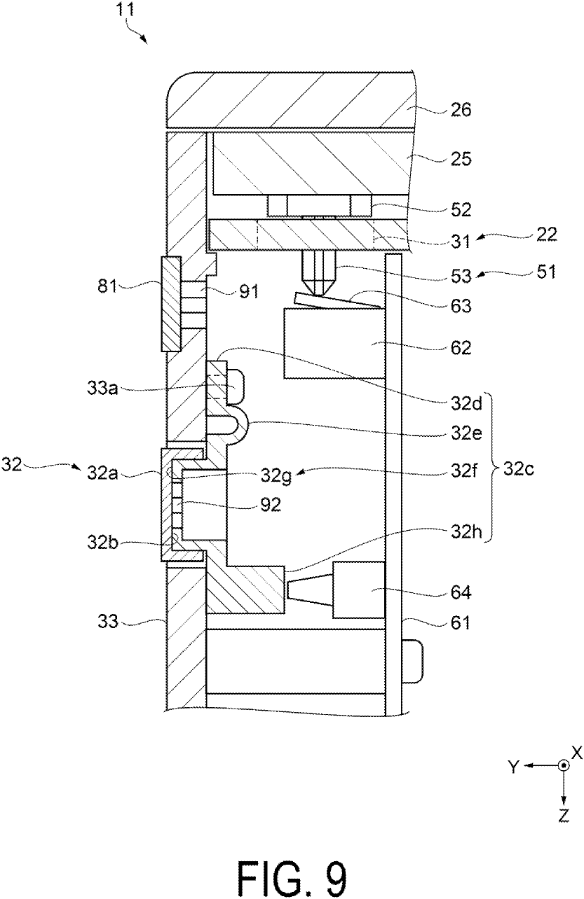

Further, as illustrated in FIG. 9, a circuit board 61 is provided on the +Z direction side of the front cover 22. In the circuit board 61, a detection portion 62 is provided at a position in the +Z direction of the detection hole 31 of the front cover 22. When the reading portion 25 is in the closed position, the protrusion 53 of the detection target portion 51 is detected by the detection portion 62 by pushing a detection lever 63 of the detection portion 62. When the protrusion 53 of the detection target portion 51 is detected by the detection portion 62, the recording apparatus 11 detects that the reading portion 25 is at the closed position. A function of detecting that the reading portion 25 is located at the closed position is an example of a second function. The detection target portion 51 and the detection portion 62 that detects the detection target portion 51 are examples of a second functional portion FP2.

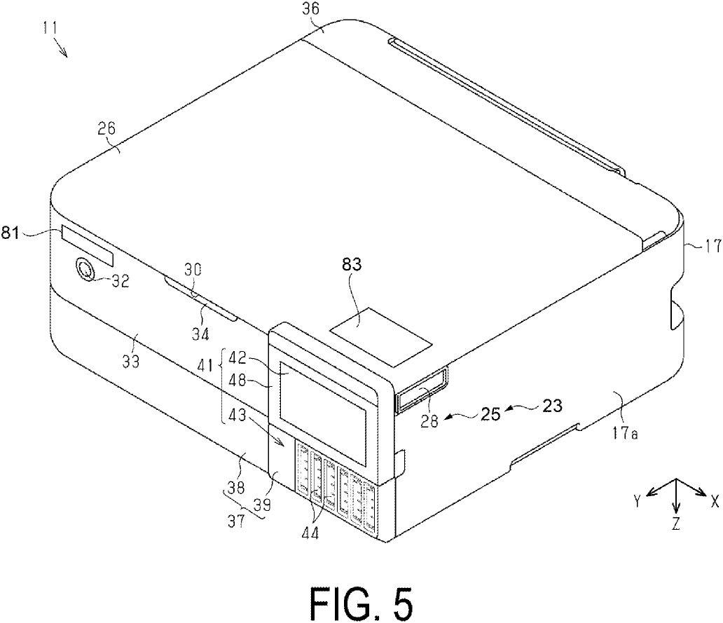

As illustrated in FIGS. 1, 5, and 6, the upper lid 26 includes a third handle portion 30. The upper lid 26 is provided so as to be swingable about a rear end of the upper lid 26 which is an end on the -Y direction side. Also, the upper lid 26 is provided to be attachable to and detachable from the housing 17. The upper lid 26 located at the closed position illustrated in FIG. 5 is moved to the open position (not illustrated) by the user pushing up the third handle portion 30. At this time, the reading portion 25 remains at the closed position. The upper lid 26 is a component EP constituting the exterior of the recording apparatus 11 itself, and is an example of a component EP including an outer surface constituting the exterior of the recording apparatus 11 itself.

As illustrated in FIGS. 1, 5, and 6, the housing 17 includes a front wall 33. The front wall 33 includes a recess 34 formed below the third handle portion 30. Since the front wall 33 includes the recess 34, the user can easily put his/her hand on the third handle portion 30. The recess 34 is located at the center of the housing 17 in the X-axis direction. The front wall 33 is a component EP constituting the exterior of the recording apparatus 11 itself, and is an example of a component EP including an outer surface constituting the exterior of the recording apparatus 11 itself.

As illustrated in FIGS. 1 to 5, the recording apparatus 11 includes a feeding cover 36. The feed cover 36 of the embodiment is located behind the upper lid 26 and is aligned with the upper lid 26 in the Y-axis direction. The feeding cover 36 is provided to be swingable about a rear end which is an end on the -Y direction side. The feeding cover 36 located at a closed position illustrated in FIG. 5 covers a feeding port (not illustrated) into which the medium M is inserted. The feeding port is exposed when the feeding cover 36 is located at an open position (not illustrated).

As illustrated in FIGS. 1 and 5, the recording apparatus 11 includes a discharge cover 37. The discharge cover 37 is provided to be swingable about a lower end which is an end on the +Z direction side. The discharge cover 37 located at a closed position illustrated in FIG. 5 covers a discharge port (not illustrated) through which the medium M is discharged. The discharge port is exposed when the discharge cover 37 is located at an open position (not illustrated). The discharge cover 37 includes a first cover portion 38 located on the +Z direction side of the front wall 33 and a second cover portion 39 located on the +Y direction side of the first cover portion 38. In the Y-axis direction, a front surface of the first cover portion 38 located at the closed position is located at the same position as the front surface of the front wall 33.

The recording apparatus 11 includes a notification portion 41 located at an end of the housing 17 on the +X direction side in the X-axis direction. The notification portion 41 is located in front of the +Y direction side of the first handle portion 28 so as to be aligned with the first handle portion 28 in the Y-axis direction. The notification portion 41 is located at a right end when the housing 17 is seen from the front. The notification portion 41 is located on the +Y direction side with respect to the front wall 33. In the Y-axis direction, a front surface of the notification portion 41 is located on the +Y direction side with respect to the front surface of the front wall 33, and is located at the same position as a front surface of the second cover portion 39.

The notification portion 41 includes a display panel 42 and a viewing window 43. The housing 17 includes the viewing window 43 that allows a liquid level of the liquid stored in each of the storage portions 14 to be visually recognized from the outside through a transmissive region 44 included in each of the storage portions 14. Here, the transmissive region 44 has a light transmitting property.

The notification portion 41 includes a frame body 48 provided around the display panel 42. The display panel 42 is provided at a front end of the reading mechanism 23 so as to face forward. The display panel 42 is provided so as to be movable together with the reading mechanism 23. Display on the display panel 42 is controlled by the control portion 15. The display panel 42 may be constituted by a touch panel for performing various operations of the recording apparatus 11. The viewing window 43 is provided so as to face forward, and allows the liquid accommodated in the storage portion 14 to be visually recognized from the front.

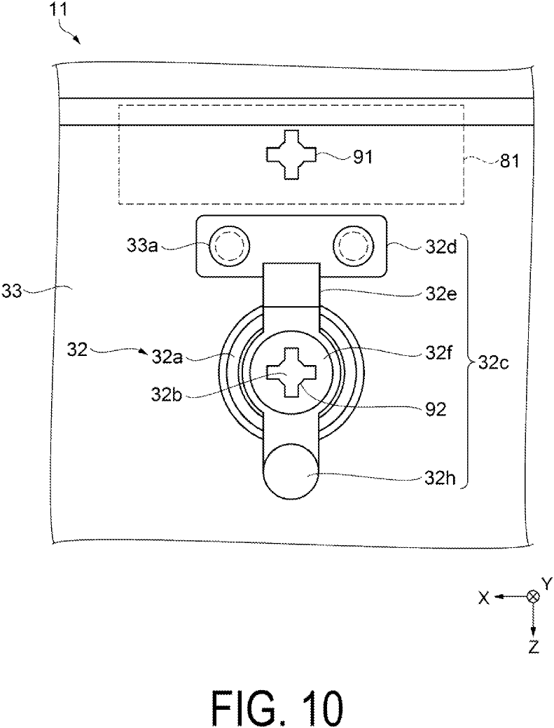

As illustrated in FIGS. 1, 5, and 6, the recording apparatus 11 includes an operation button 32 on the front wall 33. The operation button 32 is a power button for turning on and off power of the recording apparatus 11. As illustrated in FIGS. 9 and 10, the operation button 32 includes a pressing portion 32c and a cap 32a fixed to the pressing portion 32c. In the embodiment, the cap 32a is formed of a metal material, for example, aluminum for the purpose of decoration. On the other hand, the pressing portion 32c is formed of a resin material, for example, polyoxymethylene (POM) in consideration of durability. That is, the cap 32a is formed of a material which is not compatible with the pressing portion 32c.

The term “compatibility” as used herein means that, for example, when two or more kinds of polymer materials are mixed, they are dissolved in each other. Simple mixing is distinguished from compatibility because it merely disperses the materials and does not dissolve together.

The pressing portion 32c includes a mounting portion 32d, a hinge 32e, a cap mounting portion 32f, and a pressing protrusion 32h. The operation button 32 is mounted on the front wall 33 by the mounting portion 32d being fixed to the mounting protrusion 33a of the front wall 33. The cap 32a is combined with the pressing portion 32c by being fixed to the pressing portion 32f. A method of fixing the cap 32a to the cap mounting portion 32f is not particularly limited as long as the cap 32a and the pressing portion 32c can be separated from each other, and for example, engagement by press-fitting, caulking, hooks, or the like, and bonding by an adhesive, a double-sided tape, or the like can be adopted. The pressing portion 32c is an example of a first component P1, and the cap 32a is an example of a second component P2 to be combined with the first component P1. In the following description, one of the first component P1 and the second component P2 is referred to as the first component P1, and the other of the first component P1 and the second component P2 is referred to as the second component P2.

For example, when the user presses the cap 32a fixed to the pressing portion 32c, the hinge 32e is deformed and the pressing protrusion 32h presses a power switch 64. That is, when the user presses the cap 32a of the operation button 32, the power switch 64 is pressed and the power of the recording apparatus 11 is turned on or off. The function of turning on and off the power supply of the recording apparatus 11 is an example of a first function. The operation button 32 and the power switch 64 are examples of a first functional portion FP1.

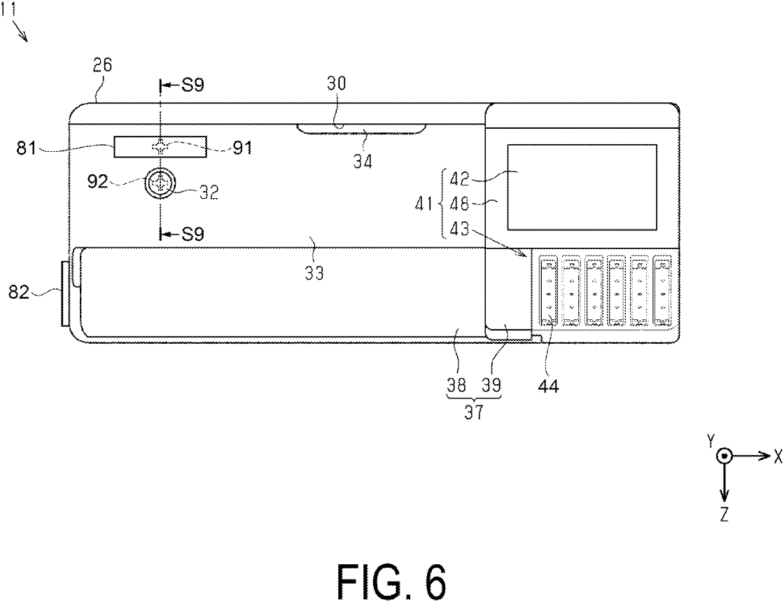

A facing surface 32g that faces a back surface 32b of the cap 32a fixed to the cap mounting portion 32f is provided on the cap mounting portion 32f. Further, as illustrated in FIGS. 6, 9, and 10, a through hole 92 is provided in the facing surface 32g at a position facing the back surface 32b of the cap 32a fixed to the cap mounting portion 32f. The through hole 92 has a cross shape having such a size that the protrusion 53 of the detection target portion 51 can be inserted thereinto. The shape of the through hole 92 may be a circular shape, a rectangular shape, or the like as long as the protrusion 53 of the detection target portion 51 can be inserted therein.

As illustrated in FIGS. 1, 5, and 6, the recording apparatus 11 includes a plate 81 at a position on the -Z direction side of the operation button 32 on the front wall 33. The plate 81 is a name plate on which a product name of the recording apparatus 11 or a logo of a manufacturer name of the recording apparatus 11 is provided. The plate 81 has a function of clearly indicating the product name of the recording apparatus 11 or the manufacturer name of the recording apparatus 11 by being fixed to the front wall 33. The function of indicating the product name of the recording apparatus 11 or the manufacturer name of the recording apparatus 11 is an example of a first function. The plate 81 and the front wall 33 on which the plate 81 is mounted are an example of a first functional portion FP1. Further, the front wall 33 is an example of the first component P1, and the plate 81 is an example of the second component P2 to be combined with the first component P1.

A method of fixing the plate 81 to the front wall 33 is not particularly limited as long as the plate 81 can be separated from the front wall 33, and for example, engagement by press-fitting, caulking, hooks, or the like, and bonding by an adhesive, a double-sided tape, or the like can be adopted.

In the embodiment, the plate 81 is formed of a metal material, for example aluminum, for the purpose of decoration. On the other hand, the front wall 33 is formed of a resin material, for example, acrylonitrile butadiene styrene (ABS). That is, the plate 81 is formed of a material that is not compatible with the front wall 33. As illustrated in FIGS. 6 and 9, a through hole 91 is formed in the front wall 33 at a position facing the plate 81 mounted on the front wall 33. The through hole 91 has a cross shape having such a size that the protrusion 53 of the detection target portion 51 can be inserted thereinto. The shape of the through hole 91 may be a circular shape, a rectangular shape, or the like as long as the protrusion 53 of the detection target portion 51 can be inserted therein.

As illustrated in FIGS. 1, 2, 4, and 12, the recording apparatus 11 includes a sound absorbing portion 71 inside the housing 17. The sound absorbing portion 71 reduces, for example, an echo sound generated in the housing 17 when the carriage 13 moves. For example, two sound absorbing portions 71 are provided at a position between a region in which the carriage 13 moves and the right side wall 17a and a position between the region in which the carriage 13 moves and the left side wall 17b in the X-axis direction. The function of reducing the echo sound generated in the housing 17 is an example of a first function. The sound absorbing portion 71 is an example of the first functional portion FP1.

The sound absorbing portion 71 includes a fixing member 72 and a sound absorbing material 73 fixed to the fixing member 72. A method of fixing the sound absorbing material 73 to the fixing member 72 is not particularly limited as long as the fixing member 72 and the sound absorbing material 73 can be separated from each other, and in the embodiment, a double-sided tape is employed. The sound absorbing portion 71 is fixed to the housing 17 by the fixing member 72 being regulated by a regulating portion provided in the housing 17 and the front cover 22. The fixing member 72 is an example of the first component P1, and the sound absorbing material 73 is an example of the second component P2 combined with the first component P1.

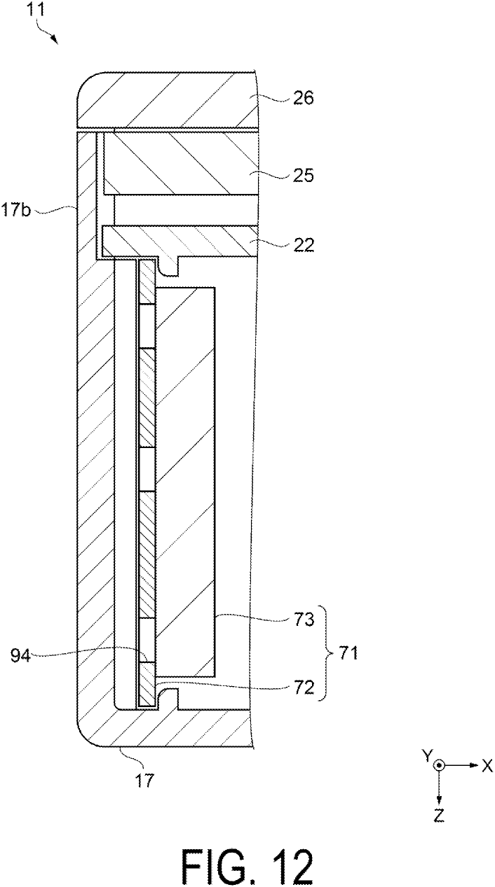

In the embodiment, the sound absorbing material 73 is formed of a porous member, for example, sponge-like urethane. The fixing member 72 is formed of a resin material, for example, polypropylene (PP). That is, the sound absorbing material 73 is formed of a material which is not compatible with the fixing member 72. As illustrated in FIGS. 4 and 12, a plurality of through holes 94 are formed in the fixing member 72 at positions facing the sound absorbing material 73 mounted on the fixing member 72. Each of the through hole 94 has a rectangular shape having such a size that the protrusion 53 of the detection target portion 51 can be inserted thereinto. The shape of the through hole 94 may be a circular shape, a cross shape, or the like as long as the protrusion 53 of the detection target portion 51 can be inserted therein.

As illustrated in FIGS. 3, 4, and 13, the recording apparatus 11 includes a display label 86. For example, the display label 86 is attached and fixed to an attachment surface 17c provided on the outer surface of the left side wall 17b of the housing 17. A method of fixing the display label 86 to the attachment surface 17c is not particularly limited as long as the display label 86 can be separated from the housing 17, and in the embodiment, bonding by an adhesive is adopted. The housing 17 is an example of the first component P1, and the display label 86 is an example of the second component P2 to be combined with the first component P1. The display label 86 is, for example, a label on which an identification number, a date of manufacture, and a country of manufacture of the recording apparatus 11 are written. It is possible to identify each individual in the manufactured recording apparatus 11 by confirming the contents described on the display label 86. That is, the display label 86 is an example of a display portion DP that displays apparatus information SR different from disassembly-related information BR which is information related to the disassembly of the recording apparatus 11 itself.

The display label 86 is fixed to the attachment surface 17c of the housing 17 to indicate information for identifying the respective individual recording apparatuses 11. The function of indicating the information for identifying the respective individual recording apparatuses 11 is an example of the first function. The display label 86 and the housing 17 to which the display label 86 is attached are an example of the first functional portion FP1. In the embodiment, the display label 86 is formed of a resin film, for example, a film-shaped polyethylene terephthalate (PET) resin. The housing 17 is formed of a polystyrene (PS) resin. That is, the display label 86 is formed of a material that is not compatible with the housing 17.

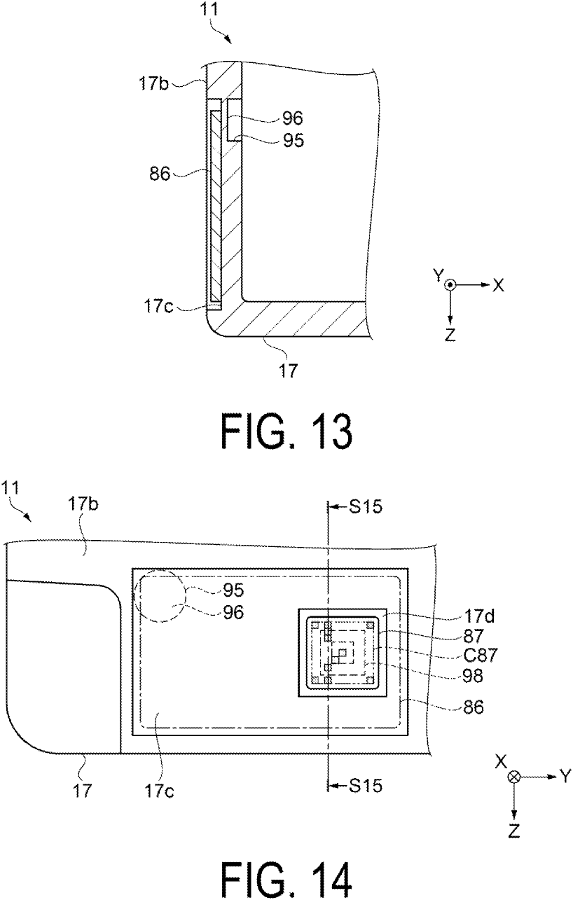

As illustrated in FIGS. 4 and 13, in the left side wall 17b of the housing 17, a recessed portion 95 opening to an inner space of the housing 17 is provided in a rear region which is the +X direction side of the attachment surface 17c. As a result, a thin portion 96 constituting a bottom surface of the recessed portion 95 is provided on the left side wall 17b. The thin portion 96 of the left side wall 17b is provided at a position facing the display label 86 fixed to the attachment surface 17c. The thin portion 96 of the left side wall 17b is thinner than the rear region of the attachment surface 17c surrounding the thin portion 96. The recessed portion 95 has a circular shape having such a size that the protrusion 53 of the detection target portion 51 can be inserted thereinto. The shape of the recessed portion 95 may be a rectangular shape, a cross shape, or the like as long as the protrusion 53 of the detection target portion 51 can be inserted therein.

In addition, as illustrated in FIGS. 3 and 4, the recording apparatus 11 includes a card 82. The card 82 is provided on the left side wall 17b of the housing 17 so that written contents thereof can be visually recognized. The card 82 is inserted into and held by a transparent card holder mounted on the outer surface of the left side wall 17b of the housing 17. The card 82 may be a business card of a serviceman who is in charge of maintenance or the like of the recording apparatus 11. On the card 82, the name and contact information of a serviceman in charge of maintenance or the like of the recording apparatus 11, and contact information such as an inquiry about the recording apparatus 11 are written. That is, the card 82 is an example of the display portion DP that displays the apparatus information SR different from the disassembly-related information BR. The card holder is detachably fixed to the outer surface of the left side wall 17b of the housing 17 with an adhesive.

Further, as illustrated in FIGS. 3 and 5, the recording apparatus 11 includes an instruction label 83. The instruction label 83 is attached and fixed to an outer surface of the upper lid 26, for example. On the instruction label 83, for example, information about an operation method of the recording apparatus 11 such as a method of opening and closing the upper lid 26, a method of opening and closing the reading portion 25, and a method of setting a document in the reading mechanism 23 is described. That is, the instruction label 83 is an example of the display portion DP that displays the apparatus information SR different from the disassembly-related information BR. The instruction label 83 is detachably fixed to the upper lid 26 with an adhesive. The upper lid 26 is the component EP constituting the exterior of the recording apparatus 11 itself, and is an example of the component EP including an outer surface constituting the exterior of the recording apparatus 11 itself.

As illustrated in FIG. 1, the recording apparatus 11 includes a control portion 15 inside the housing 17. The control portion 15 includes a central processing portion (CPU) (not illustrated) and a memory (not illustrated). The CPU can execute various programs stored in the memory, and can perform, for example, various determinations and various instructions. For example, various programs such as a program for transporting the medium M, various programs such as a program related to a display method for displaying a state of the recording apparatus 11 on the display panel 42, various tables, various counter values, and the like are stored in the memory.

The control portion 15 controls the entire recording apparatus 11. For example, when recording is performed on the medium M, the control portion 15 controls the carriage 13, the liquid ejection head 12, and the transport portion, and performs recording on the medium M transported by the transport portion by ejecting ink from the liquid ejection head 12 that moves in the width direction of the medium M together with the carriage 13.

Further, for example, the control portion 15 controls the reading mechanism 23 to read an image printed on a document set on the reading portion 25. In addition, for example, the control portion 15 detects whether the reading portion 25 is at the closed position or the open position based on a detection result of the detection target portion 51 by the detection portion 62. In addition, for example, the control portion 15 performs notification processing of displaying information regarding the state of the recording apparatus 11 on the display panel 42 and notifying the user of the information.

Next, a method of separating the pressing portion 32c and the cap 32a constituting the operation button 32, a method of separating the plate 81 from the front wall 33, a method of separating the fixing member 72 and the sound absorbing material 73 constituting the sound absorbing portion 71, and a method of separating the display label 86 from the housing 17 will be described.

For example, when the separating operation described above is performed in the disassembling operation of the recording apparatus 11, the operator removes the detection target portion 51 from the reading portion 25 of the reading mechanism 23 prior to the separating operation described above.

For example, when the pressing portion 32c and the cap 32a constituting the operation button 32 are separated from each other, the operator inserts the protrusion 53 of the detection target portion 51 into the through hole 92 provided in the facing surface 32g of the pressing portion 32c in a direction from the -Y direction side toward the +Y direction in FIGS. 9 and 10. Then, the operator presses the back surface 32b of the cap 32a with a tip end of the protrusion 53. As a result, a pressing force acts in a direction in which the pressing portion 32c and the cap 32a are separated from each other, so that the pressing portion 32c and the cap 32a are separated from each other. In the embodiment, the protrusion 53 is formed of a material harder than that of the cap 32a. Further, the protrusion 53 is formed of a material harder than that of the pressing portion 32c.

For example, when the plate 81 are separated from the front wall 33, the operator inserts the protrusion 53 of the detection target portion 51 into the through hole 91 provided in the front wall 33 in the direction from the -Y direction side toward the +Y direction in FIGS. 9 and 10. Then, the operator presses the plate 81 with the tip end of the protrusion 53. As a result, the pressing force acts in the direction in which the plate 81 is separated from the front wall 33, so that the plate 81 is separated from the front wall 33. In the embodiment, the protrusion 53 is formed of a material harder than that of the plate 81. Further, the protrusion 53 is formed of a material harder than that of the front wall 33.

In addition, for example, when the fixing member 72 and the sound absorbing material 73 constituting the sound absorbing portion 71 are separated from each other, the operator takes out the sound absorbing portion 71 from the housing 17. Then, the operator inserts the protrusion 53 of the detection target portion 51 into the through hole 94 provided in the fixing member 72. Then, the operator presses the sound absorbing material 73 with the tip end of the protrusion 53. As a result, a pressing force acts in a direction in which the fixing member 72 and the sound absorbing material 73 are separated from each other, so that the fixing member 72 and the sound absorbing material 73 are separated from each other. In the embodiment, the protrusion 53 is formed of a material harder than that of the sound absorbing material 73. Further, the protrusion 53 is formed of a material harder than the fixing member 72.

In addition, for example, when the housing 17 and the display label 86 are separated from each other, the operator inserts the protrusion 53 of the detection target portion 51 into the recessed portion 95 provided in the back region of the attachment surface 17c of the housing 17 in a direction from the +X direction side toward the -X direction in FIGS. 4 and 13. Then, the operator presses a bottom surface of the recessed portion 95 with the tip end of the protrusion 53. As a result, the thin portion 96 constituting the bottom surface of the recessed portion 95 is broken, and the pressing force acts on the display label 86 in the -X direction in which the display label 86 is separated from the housing 17, so that a pressed portion of the display label 86 is peeled off from the attachment surface 17c. Thus, the operator can easily separate the display label 86 from the attachment surface 17c. In the embodiment, the protrusion 53 is formed of a material harder than that of the thin portion 96 of the housing 17. Also, the protrusion 53 is formed of a material harder than that of the display label 86.

The through holes 91, 92, and 94 and the recessed portion 95 may have such a size or a shape that a tool used when the recording apparatus 11 is disassembled cannot be inserted thereinto. For example, it is assumed that a size of a driver corresponding to a fixing screw used for assembling the recording apparatus 11 is No. 02 of the JIS standard which is generally used in consideration of assemblability and disassemblability of the recording apparatus 11. In this case, even when the through holes 91, 92, and 94 and the recessed portion 95 have such a size that the driver of No. 02 of the JIS standard cannot be inserted thereinto, in the embodiment, since the size is set so that the protrusion 53 of the detection target portion 51 can be inserted thereinto, it is not necessary to prepare a separate tool for disassembly.

As illustrated in FIGS. 4, 14, and 15, the recording apparatus 11 of the embodiment includes an information medium 87. FIG. 14 to FIG. 18 are views in a state in which the display label 86 is removed, and the display label 86 is indicated by an alternated long and short dash line.

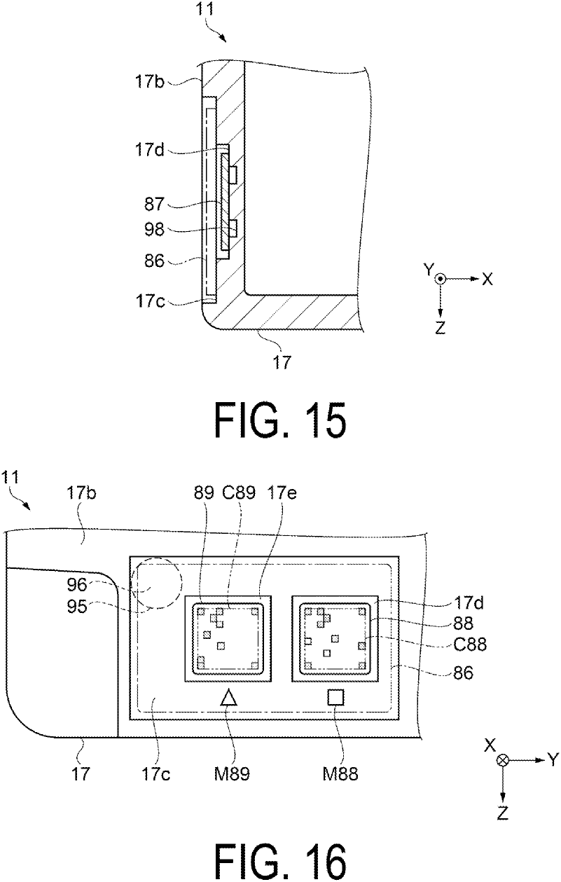

For example, as illustrated in FIGS. 14 and 15, the information medium 87 is attached and fixed to an information medium surface 17d provided on the outer surface of the left side wall 17b of the housing 17. The information medium surface 17d is an example of the outer surface of the housing 17. The information medium 87 is detachably fixed to the information medium surface 17d with an adhesive. The information medium surface 17d is provided in the attachment surface 17c. The information medium surface 17d is a rectangular recessed surface located on the +X direction side with respect to the attachment surface 17c. Since the information medium surface 17d is provided, the display label 86 can be easily peeled off from the attachment surface 17c. In the embodiment, an annular groove 98 is provided in the information medium surface 17d so that the information medium 87 can be easily peeled off from the information medium surface 17d.

The information medium 87 provided on the information medium surface 17d is covered with the display label 86 fixed to the attachment surface 17c and cannot be visually recognized. Thus, as illustrated in FIG. 4, a mark M1 that indicates a location at which the information medium 87 is provided is provided on the display label 86 covering the information medium 87. When the mark M1 is not provided on the display label 86, for example, the mark M1 may be provided at a position adjacent to the display label 86 on the outer surface of the left side wall 17b of the housing 17.

The information medium 87 can access disassembly-related information BR related to the disassembly of the recording apparatus 11 itself. As indicated by a two dot chain line in FIG. 14, the information medium 87 in the embodiment is a label on which a two-dimensional code C87 configured to provide access to the disassembly-related information BR is written. The information medium 87 may be a label on which a bar code configured to provide access to the disassembly-related information BR is written. Alternatively, the information medium 87 may be a label on which a character string configured to provide access to the disassembly-related information BR is written.

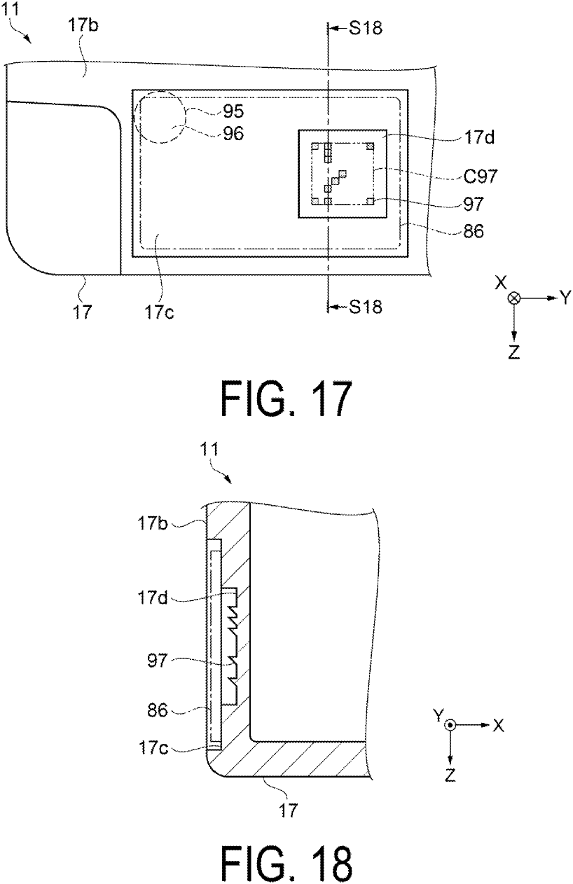

Alternatively, as illustrated in FIGS. 17 and 18, instead of the information medium 87, an information medium 97 including a two-dimensional code C97 configured to provide access to the disassembly-related information BR may be provided. The two-dimensional code C97 is formed by an uneven structure constituted by an information medium surface 17b provided on the outer surface of the left side wall 17d of the housing 17 and a convex portion integrally formed at the information medium surface 17d. In this case, it can be said that the information medium 97 provided on the information medium surface 17d is constituted by the uneven structure formed at the outer surface of the housing 17.

Further, in this case, the information medium surface 17d reflects light from a code reader toward a light receiving portion of the code reader, and the convex portion formed integrally on the information medium surface 17d reflects light from the code reader toward a direction different from the light receiving portion of the code reader. That is, in FIG. 17, the information medium surface 17d located in a rectangle indicated by the two dot chain line corresponds to a space in the two-dimensional code C97, and the convex portion located in the rectangle indicated by the two dot chain line corresponds to a dot in the two-dimensional code C97.

The disassembly-related information BR may be information about the disassembly of the entire recording apparatus 11 including a method of separating the reading mechanism 23, the front cover 22, the rear cover 27, the carriage 13, the storage portion 14, the circuit board 61, and the like from the housing 17, or may be information about the disassembly of a specific component of the recording apparatus 11 such as the front cover 22.

In addition, the disassembly-related information BR may include a method of separating the pressing portion 32c and the cap 32a constituting the operation button 32, a method of separating the plate 81 from the front wall 33, a method of separating the fixing member 72 and the sound absorbing material 73 constituting the sound absorbing portion 71, and a method of separating the display label 86 from the housing 17.

In addition, the disassembly-related information BR may include an assembly method of the recording apparatus 11 itself. In this case, the information medium 87, 97 can provide access to information about the assembly of the recording apparatus 11 itself. Further, the disassembly-related information BR may also include information about a tool used for disassembly. In addition, the disassembly-related information BR may be disassembly-related information BR applied globally regardless of a usage region of the recording apparatus 11, or may include disassembly-related information BR corresponding to a rule defined in the usage region of the recording apparatus 11.

As described above, according to the recording apparatus 11 of Embodiment 1, the following effects can be obtained.

The recording apparatus 11 includes a component EP that constitutes an exterior of the recording apparatus 11 itself and includes an outer surface constituting the exterior, an information medium 87, 97 that is provided at an information medium surface 17d of the component EP and configured to provide access to disassembly-related information BR related to disassembly of the recording apparatus 11 itself, and a display portion DP that is provided covering the information medium 87, 97 and displays apparatus information SR different from the disassembly-related information BR. Thus, since the information medium 87, 97 which is not necessary when the user uses the recording apparatus 11 is covered with the display portion DP which is necessary when the user uses the recording apparatus 11, it is possible to suppress deterioration of the exterior of the recording apparatus 11 due to the information medium 87, 97 constituting a part of the exterior of the recording apparatus 11.

The information medium 87, 97 includes two-dimensional code C87, C97 configured to provide access to the disassembly-related information BR. Thus, it is possible to reduce an area occupied by the information medium 87, 97.

The information medium 87, 97 is configured to provide access to information about the assembly of the recording apparatus 11 itself. Thus, it is possible to obtain information about the assembly of the recording apparatus 11 itself by the information medium 87, 97.

The display portion DP is a display label 86 on which an identification number of the recording apparatus 11 itself is described as the apparatus information SR. Thus, since the information medium 87, 97 is covered with the display label 86 which traditionally constitutes the exterior of the recording apparatus 11, it is possible to suppress the deterioration of the exterior of the recording apparatus 11.

The information medium 97 is constituted by an uneven structure formed at an information medium surface 17d on the outer surface side of the component EP. Thus, the information medium 97 can be provided without increasing the number of man-hours required for disassembling the recording apparatus 11 itself.

The information medium 87 is a label. Thus, it is possible to easily provide the information medium 87 in the recording apparatus 11.

A mark M1 that indicates a location at which the information medium 87, 97 is provided is provided at the display portion DP. Thus, a mounting location of the information medium 87, 97 can be easily grasped.

Although the recording apparatus 11 according to the above embodiment of the present disclosure is basically configured as described above, it is also possible to change or omit a partial configuration within a range that does not deviate from the gist of the present disclosure. Further, the above embodiment and other embodiments described below can be combined with each other within a technically consistent range. Other exemplary embodiments will be described below.

In the above embodiment, the information medium 87, 97 need not be covered with the display label 86 as long as it does not constitute the exterior of the recording apparatus 11. For example, the information medium 87, 97 may be covered with the instruction label 83. In this case, the information medium surface 17d on which the information medium 87, 97 is provided is provided at a position covered with the instruction label 83 on the outer surface of the upper lid 26. In this case, the display portion DP is the instruction label 83 on which a method of using the recording apparatus 11 itself is described as the apparatus information SR. Thus, since the information medium 87, 97 is covered with the instruction label 83 which traditionally constitutes the exterior of the recording apparatus 11, it is possible to suppress the deterioration of the exterior of the recording apparatus 11. Further, for example, the information medium 87, 97 may be covered with the card 82. In this case, the information medium 87, 97 is formed at the outer surface of the left side wall 17b of the housing 17 at a position covered with the card holder into which the card 82 is inserted. Further, when the information medium is the label-like information medium 87, the information medium 87 may be attached and fixed to a position covered with the card 82 in the card holder fixed to the outer surface of the housing 17.

In the above embodiment, the recording apparatus 11 may include the information medium 87 divided into a plurality of information medium 88 and 89 as illustrated in FIG. 16. In this case, for example, the information medium 88, instead of the information medium 87, is attached and fixed to the information medium surface 17d provided on the outer surface of the left side wall 17b of the housing 17. In addition, an information medium surface 17e similar to the information medium surface 17d is provided at a position adjacent to the information medium surface 17d on the -Y direction side of the information medium surface 17d on the attachment surface 17c. Then, the information medium 89 is attached and fixed to the information medium surface 17e. Then, a mark M88 that indicates a location at which the information medium 88 is provided is provided on the attachment surface 17c at a position on the +Z direction side of the information medium surface 17d and adjacent to the information medium surface 17d. In addition, a mark M89 that indicates a location at which the information medium 89 is provided is provided on the attachment surface 17c at a position on the +Z direction side of the information medium surface 17e and adjacent to the information medium surface 17e.

The information medium 88 is a label on which a two-dimensional code C88 configured to provide access to any one of the above disassembly-related information BR is written. The information medium 89 is a label on which a two-dimensional code C89 configured to provide access to any one of the above disassembly-related information BR is written. For example, the information medium 88 may be configured to provide access to the information about the disassembly of the recording apparatus 11 itself, and the information medium 89 may be configured to provide access to information about the assembly of the recording apparatus 11 itself. Alternatively, the information medium 88 may be configured to provide access to the information about the disassembly of the entire recording apparatus 11, and the information medium 89 may be configured to provide access to the information about the disassembly of a specific component included in the recording apparatus 11. Alternatively, the information medium 88 may be configured to provide access to the information about the disassembly of the entire recording apparatus 11, and the information medium 89 may be configured to provide access to the information about a tool used for disassembly of the recording apparatus 11. Alternatively, the information medium 88 may be configured to provide access to the information about the disassembly applied globally regardless of the usage region of the recording apparatus 11, and the information medium 89 may be configured to provide access to the information about the disassembly corresponding to a rule defined in the usage region of the recording apparatus 11. Any one of the information media 88 and 89 may be a label on which a bar code configured to provide access to the information about the disassembly of the recording apparatus 11 itself is written, or may be constituted by the uneven structure formed at the information medium surfaces 17d and 17e.

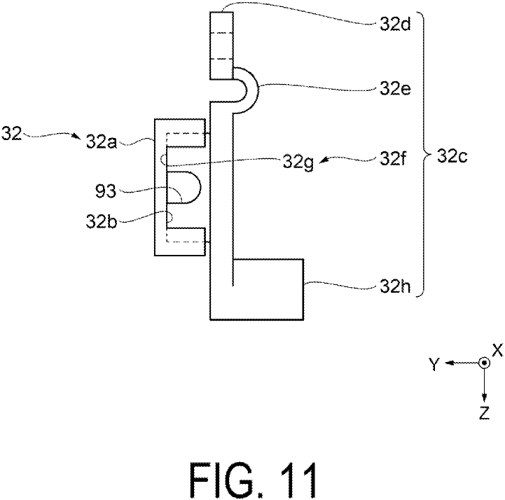

In the above embodiment, the through hole 92 provided in the operation button 32 need not be provided in the pressing portion 32c. For example, instead of the through hole 92, a through hole 93 may be provided in a joint portion between the pressing portion 32c and the cap 32a. In other words, the through hole 93 provided in the operation button 32 which is an example of the first functional portion FP1 may be formed by the pressing portion 32c which is an example of the first component P1 and the cap 32a which is an example of the second component P2. For example, as illustrated in FIG. 11, the through hole 93 may be formed by a recessed portion provided in the facing surface 32g of the pressing portion 32c and the back surface 32b of the cap 32a. In this case, when the pressing portion 32c and the cap 32a constituting the operation button 32 are separated from each other, the operator removes the operation button 32 from the front wall 33. Then, the operator inserts the protrusion 53 of the detection target portion 51 into the through hole 93 formed by the pressing portion 32c and the cap 32a in a direction along the X-axis in which the through hole 93 extends in FIG. 11. Then, for example, the operator gouges the protrusion 53 in a direction intersecting the X-axis. As a result, the pressing force acts in a direction in which the pressing portion 32c and the cap 32a are separated from each other, so that the pressing portion 32c and the cap 32a are separated from each other. Also in the embodiment, the protrusion 53 is formed of a material harder than that of the cap 32a. The protrusion 53 is formed of a material harder than that of the pressing portion 32c. Thus, when the pressing portion 32c and the cap 32a are separated from each other, the protrusion 53 is unlikely to be broken.

In the above embodiment, the protrusion 53 of the detection target portion 51 which is an example of the second functional portion FP2 may be provided to be separable from the detection target portion 51. For example, as illustrated in FIG. 8, in a protruding direction of the protrusion 53, a plurality of through holes 54 arranged in a perforation shape in a direction intersecting the protruding direction of the protrusion 53 may be provided on the base side of the protrusion 53 which is a position closer to the reading portion 25 than the center of the protrusion 53. Thus, it is possible to easily separate the protrusion 53 from the detection target portion 51 fixed to the reading portion 25 at the position of the through hole 54. In addition, when the above separation operation is performed, the operator does not need to separate the entire detection target portion 51 from the reading portion 25 of the reading mechanism 23 prior to the above separation operation.

In the above embodiment, the shape of the protrusion 53 of the detection target portion 51 when seen in a direction along the direction in which the protrusion 53 protrudes from the fixing portion 52 need not be a cross shape, and may be, for example, a circular shape or a rectangular shape.

In the above embodiment, as long as the first component P1 and the second component P2 constituting the first functional portion FP1 can be separated from each other, the protrusion 53 of the detection target portion 51 need not be formed of a material harder than that of any one of the first component P1 and the second component P2. The protrusion 53 may be formed of a resin material such as polycarbonate (PC), polyoxymethylene (POM), poly butylene terephthalate (PBT), modified poly phenylene ether (PPE), a liquid crystal polymer, or a thermosetting resin.

In the above embodiment, the cap 32a of the operation button 32 need not be formed of a metal material. The cap 32a may be formed of a resin material such as acrylonitrile butadiene styrene (ABS) and poly methyl methacrylate (PMMA).

In the above embodiment, the plate 81 need not be formed of a metal material. The plate 81 may be formed of a resin material, for example, acrylonitrile butadiene styrene (ABS) or poly methyl methacrylate (PMMA).

In the above embodiment, the display label 86 need not be formed of a PET resin. The display label 86 may be formed of synthetic paper or paper.

The recording apparatus 11 need not be an inkjet printer as long as it includes the first functional portion FP1 and the second functional portion FP2 described in the description of the embodiment. For example, the recording apparatus 11 may be a laser printer in which toner powder is melted with heat and then fixed on the medium M.

A combination of the first functional portion FP1 and the second functional portion FP2 described in the description of the embodiment may be applied to a scanner that reads an image printed on a document and captures the image as image data. In this case, the scanner is an example of the apparatus. Alternatively, the combination of the first functional portion FP1 and the second functional portion FP2 described in the description of the above embodiment may be applied to a finisher that staples the media M on which recording is performed by the recording apparatus 11 in a portion of the number of copies or performs processing of a punch hole. In this case, the finisher is an example of the apparatus.

What is claimed is:

1. An apparatus comprising:
a component constituting an exterior of the apparatus itself and including an outer surface constituting the exterior;
an information medium provided at the outer surface of the component and configured to provide access to disassembly-related information related to disassembly of the apparatus itself; and
a display portion provided covering the information medium and configured to display apparatus information different from the disassembly-related information.

2. The apparatus according to claim 1, wherein the information medium includes a two-dimensional code configured to provide access to the disassembly-related information.

3. The apparatus according to claim 2, wherein the information medium is configured to provide access to information about assembly of the apparatus itself.

4. The apparatus according to claim 2, wherein the display portion is a label on which an identification number of the apparatus itself is written as the apparatus information.

5. The apparatus according to claim 3, wherein the display portion is a label on which an identification number of the apparatus itself is written as the apparatus information.

6. The apparatus according to claim 2, wherein the display portion is a label on which a usage method of the apparatus itself is written as the apparatus information.

7. The apparatus according to claim 3, wherein the display portion is a label on which a usage method of the apparatus itself is written as the apparatus information.

8. The apparatus according to claim 1, wherein the information medium is constituted by an uneven structure formed at the outer surface of the component.

9. The apparatus according to claim 1, wherein the information medium is a label.

10. The apparatus according to claim 1, wherein a mark indicating a location at which the information medium is provided is provided at the display portion.
